(19) United States
(12) Patent Application Publication
(10) Pub. No.: US 2024/0109775 A1
(43) Pub. Date: Apr. 4, 2024

(54) HYDROGEN GENERATION IN HIGH TEMPERATURE COUNTER-CURRENT REACTOR

(71) Applicant: Exxonmobil Technology and Engineering Company, Annandale, NJ (US)

(72) Inventors: Everett J. O'Neal, Spring, TX (US); David C. Dankworth, Princeton, NJ (US); Keith R. Hajkowski, Somerset, NJ (US)

(21) Appl. No.: 18/477,591

(22) Filed: Sep. 29, 2023

Related U.S. Application Data
(60) Provisional application No. 63/412,687, filed on Oct. 3, 2022.

(51) Int. Cl. C01B 3/38; B01J 19/00; B01J 19/24

(52) U.S. Cl. CPC C01B 3/386; B01J 19/0013; B01J 19/2485; C01B 3/384; B01J 2219/2413; C01B 2203/0233; C01B 2203/0811; C01B 2203/1241

(57) ABSTRACT

Systems and methods are provided for performing reforming in a manner where the flows for providing heat for the endothermic reforming reaction are counter-current to the flows for the reforming reaction. Although the flows are counter-current, the systems and methods also allow the heating profile of the reactor to have a temperature peak toward the middle of the reactor, as opposed to at the end of the reactor. This shift of the temperature peak toward the middle allows for improved heat utilization and recovery during operation of the reactor.

### CROSS REFERENCE

This Non-Provisional Patent application claims priority to U.S. Provisional Patent Application No. 63/412,687, filed Oct. 3, 2022, and titled “Hydrogen Generation A High Temperature Counter-Current Reactor”, the entire contents of which is incorporated herein by reference.

### FIELD OF THE INVENTION

Systems and methods are provided for hydrogen generation in a high temperature counter-current reactor.

### BACKGROUND OF THE INVENTION

Steam reforming is a commonly used technique for converting methane or other hydrocarbons into hydrogen and carbon oxides. One option for performing steam reforming is to use a counter-current configuration with discrete or separated flows. One flow corresponds to a flow for performing steam reforming. A second flow corresponds to a heat transfer flow that is kept separate from the volume(s) where the steam reforming is performed. The flows are arranged in a counter-current manner so that the hottest part of the heat transfer flow, at one end of the reactor, corresponds to the location where the highest reforming temperatures are provided. Having the highest temperature for reforming at the end of the reactor is beneficial due to the endothermic and reversible nature of the reforming reaction. Higher temperatures are beneficial for driving the reforming reaction closer to completion.

U.S. Pat. No. 8,168,131 describes a low pressure drop reforming reactor. The reforming reactor corresponds to a counter-current reactor. In order to allow for at least partial recovery of heat from the reforming products, after the products exit from the reforming reaction volume, the reforming products are mixed with the heating flow that is passed in a counter-current manner around the reforming reaction volume.

U.S. Pat. No. 7,918,906 describes a steam reforming reactor with a linear countercurrent heat exchanger. An outer volume of the reactor corresponds to a boiling water heat exchanger. Heat is provided for the reactor by combusting a first portion of a reactant flow. The partially combusted reactant flow is then used as the feed for reforming.

U.S. Pat. No. 7,094,363 describes a process for the preparation of synthesis gas.

U.S. Pat. No. 7,744,664 describes a compact counterflow fuel reformer.

U.S. Pat. Nos. 7,815,873 and 8,754,276 provide examples of using reverse flow reactors to perform various endothermic processes in a cyclic reaction environment.Reverse flow reactors are an example of a reactor type that is beneficial for use in processes with cyclic reaction conditions. For example, due to the endothermic nature of reforming reactions, additional heat needs to be introduced on a consistent basis into the reforming reaction environment. Reverse flow reactors can provide an efficient way to introduce heat into the reaction environment. After a portion of the reaction cycle used for reforming or another endothermic reaction, a second portion of the reaction cycle can be used for combustion or another exothermic reaction to add heat to the reaction environment in preparation for the next reforming step.

U.S. Patent Application Publication 2020/0030778 describes monolith structures for use in hydrocarbon reforming where the monolith structures are composed of a mixture of one or more dopant metal oxides and one or more structural oxides. The dopant metal(s) and structural oxide(s) are selected based on the relative Gibbs free energy values for the dopant metal oxide and the structural oxide. NiO and A1 2 0 3 are described as an example of a suitable combination of a dopant metal oxide and a structural oxide for forming a monolith structure. The monolith structures can be used in cyclic flow reactors.

U.S. Patent Application Publication 2022/0112082 describes catalyst systems for reforming in cyclic flow reactors. Monoliths for supporting the catalyst systems are also described. Some examples of monoliths are described with compositions corresponding to 93 wt %-95 wt % alumina, 4.0 wt %-5.0 wt % SiO₂, and optionally 1.0 wt %-2.0 wt % of MgO, TiO₂, and/or Na₂O. It is noted that the channels in these monoliths corresponded to square channels.

### SUMMARY OF THE INVENTION

In an aspect, a method for performing counter-current reforming is provided. The method includes passing a fuel into a fuel flow path and an oxygen-containing gas into an oxidant flow path in a recuperation zone of a reactor volume. The method further includes passing a reforming input flow containing at least one hydrocarbon into a plurality of reforming flow channels in a reforming zone of the reactor volume. A flow direction of the reforming input flow can be substantially counter-current to a flow direction of at least one of the fuel and the oxygen-containing gas. The reforming channels can include a reforming catalyst in the reforming zone. The method further includes mixing the fuel and the oxygen-containing gas in one or more heating flow channels of a mixing zone of the reactor volume to form a fuel mixture. The mixing zone can be adjacent to the recuperation zone, with an opposing side of the mixing zone being adjacent to the reforming zone. The method further includes reacting the mixture in the one or more heating flow channels in at least one of the mixing zone and the reforming zone to generate heat and an oxidized product flow. The one or more heating flow channels can be arranged around the plurality of reforming flow channels. The method further includes reforming at least a portion of the at least one hydrocarbon in the reforming channels under reforming conditions to form a reforming product flow. The method further includes exhausting the reforming product flow from the recuperation zone. Additionally, the method includes exhausting the oxidized product flow from the reforming zone.

In another aspect, a counter-current reforming reactor is provided. The reactor includes a reactor volume. The reactor volume can include a recuperation zone, one or more mixing elements in a mixing zone, a reforming zone, a first plurality of flow channels, and one or more second flow channels. At least a portion of the first plurality of flow channels can reside in the reforming zone. The at least a portion of the first plurality of flow channels can include reforming catalyst on one or more surfaces of the first plurality of flow channels in the reforming zone. The mixing zone can be adjacent to the recuperation zone, with an opposing side of the mixing zone being adjacent to the reforming zone. The one or more second flow channels can be arranged around the first plurality of flow channels. The recuperation zone can include at least an oxidant flow path and a fuel flow path. At least one of the fuel flow path and the oxidant flow path can provide fluid communication between an end of the recuperation zone and the mixing zone without providing fluid communication between the oxidant flow path and the fuel flow path in the recuperation zone.

### BRIEF DESCRIPTION OF THE DRAWINGS

FIG. 1 shows an example of a side view of a stack of internal elements for a counter-current reforming reactor.

FIG. 2 shows a cross-sectional view of an example configuration for monoliths within a counter-current reforming reactor.

FIG. 3 shows an example of a temperature profile for a counter-current reforming reactor.

### DETAILED DESCRIPTION OF THE EMBODIMENTS

All numerical values within the detailed description and the claims herein are modified by “about” or “approximately” the indicated value, and take into account experimental error and variations that would be expected by a person having ordinary skill in the art.

### Overview

In various aspects, systems and methods are provided for performing reforming in a manner where the flows for providing heat for the endothermic reforming reaction are counter-current to the flows for the reforming reaction. Although the flows are counter-current, the systems and methods also allow the heating profile of the reactor to have a temperature peak toward the middle of the reactor, as opposed to at the end of the reactor. This shift of the temperature peak toward the middle allows for improved heat utilization and recovery during operation of the reactor.

Conventionally, counter-current reactors can be used for steam reforming. In a conventional counter-current reactor, a first volume of the reactor is used for heating flows while another volume, typically contained within the first volume, corresponds to the volume where steam reforming occurs. In such a conventional configuration, the volumes are arranged so that the heating flow does not enter the second volume where the reforming reaction occurs. This avoids any problems due to dilution and/or contamination of the reactants for steam reforming prior to completion of the reforming reaction.

One of the difficulties with conventional methods for performing steam reforming using counter-current flows is that the highest temperatures in the reactor are at the end of the reactor. This is due to the fact that the heating flow is heated prior to being introduced into the counter-current environment. Thus, the heating flow is at the maximum temperature when it first enters the counter-current environment. In order to take advantage of this maximum temperature, catalyst is included all of the way to the end of the reactor environment. However, this reduces or minimizes the opportunities for recuperating heat from the reformed product.

In contrast to this conventional design, in various aspects a counter-current reactor configuration is provided where the reforming zone is located in a middle portion of the reactor, so that the ends of the reactor are cooler than the peak temperature, which occurs in between the ends of the reactor. This temperature profile is achieved in part by performing combustion within the heating flow volume(s) of the reactor, with the combustion delayed so that the combustion occurs away from the end of the reactor where the combustion input flows are introduced. By delaying combustion until the combustion input flows reach the interior of the heating flow volume(s), improved use of heat within the reactor can be achieved. As an example, after the reforming flow in the reactor volume(s) passes through the high temperature zone, heat exchange can be performed between the reactor volume(s) and the heating flow volume(s). This allows for pre-heating of the combustion input flow prior to combustion, and thus allows for recovery of part of a portion of the combustion heat within the process, as opposed to simply exhausting any heat not used for the endothermic reforming reaction.

Various types of configurations can be used to implement counter-current steam reforming as described herein. In some aspects, the counter-current reactor can correspond to a reactor shell that contains a plurality of monoliths, such as ceramic monoliths. The monoliths can include channels or cells. In this type of aspect, a portion of the channels (or cells) correspond to reforming flow channels for carrying reforming reactants and products, while a second portion of the channels correspond to heating flow channels for carrying combustion input flows and combustion products. The channels can be configured so that at multiple locations within the monoliths, a plurality of heating flow channels are arranged around one or more reforming flow channels. This allows heat transfer to occur either from the heating flow channels to the reforming flow channels, or from the reforming flow channels to the heating flow channels.

In other aspects, a shell and tube heat exchanger configuration can be used. In this type of configuration, the shell volume can correspond to a heating flow channel. One or more tubes serve as reforming flow channels are at least partially contained within the heating flow channel. In other words, the shell volume is arranged around the tube flow channels that are used for reforming.

In some aspects, there is substantially no fluid communication between the flow channels for performing reforming and the flow channels for heating. In such aspects, this allows the two types of flows to remain separate, so that the reforming products are not mixed with the combustion products from the heating flow. In other aspects, mixing of the reforming products with combustion input and/or combustion output flows can occur after the reforming products leave the reforming flow channels.

In some aspects, another advantage of a counter-current reforming reactor can be the ability to perform partial oxidation in the heating flow channels. Using partial oxidation in the heating flow channels can reduce the amount of heat generated per molecule of fuel, so that more fuel is needed to provide heat for the reforming reaction in the reforming flow channels. However, by performing partial oxidation, the heating flow exhaust can include at least CO in addition to H₂O and CO₂. The presence of CO (an optionally H₂) in the heating flow exhaust after partial oxidation means that a portion of the partial oxidation exhaust can be recovered for value as syngas, optionally after exposure to some type of catalyst with water gas shift activity.

In some aspects, still a further advantage of a counter-current reforming reactor can be the ability to perform a limited amount of additional steam reforming in the heating flow channels. In this type of aspect, a limited amount of reforming catalyst can be included in the heating flow channels at a location that is downstream from the location where fuel and oxygen are mixed, but upstream from where the heating flow exits from the reactor. This can allow the reforming catalyst to avoid the highest temperatures where the partial combustion initially occurs while still being in a high enough temperature zone to maintain a more favorable ratio of H₂ to CO in the resulting reforming products. Because the heating flow channels also need to provide the heat used for the reaction in the reforming flow channels, the amount of reforming occurring in the heating flow channels is limited relative to the total flow rate. But this type of configuration can provide a heating flow exhaust with an improved H₂ to CO ratio relative to a conventional partial oxidation output flow.

### Flow Channel Example—Monoliths

One type of configuration for performing counter-current reforming is to use one or more monoliths to define a first plurality of reforming flow channels and a second plurality of heating flow channels. Any convenient number of monoliths can be placed in a reactor to provide the flow channels.

The reforming flow channels can correspond to channels within the monolith that contain reforming catalyst deposited on at least a portion of the surface of the channel. Although the entire length of the channel can include reforming catalyst, in some aspects the reforming catalyst can be omitted from a portion of the channel closest to the channel end in the recuperator. This allows the reforming catalyst to be present at and/or near the location of highest temperature in the reforming flow channel, but a final portion of the reforming flow channel can then be used only for heat transfer. Because reforming is an equilibrium process, having a final portion of a reforming flow channel that does not include reforming catalyst can avoid shift of the reformed products back to reactants, as the reverse (methanation) reaction becomes more favorable at lower temperatures.

The heating flow channels can correspond to channels in the monolith that do not include catalyst. However, the heating flow channels can be configured so that combustion of fuel introduced into the heating flow channels does not occur until the fuel reaches a target location away from the recuperator end of the reactor. This can be accomplished, for example, by introducing fuel and oxidant (such as air or another O₂—containing gas flow) into separate channels initially, and then mixing the fuel and oxidant using a mixer at a downstream location.

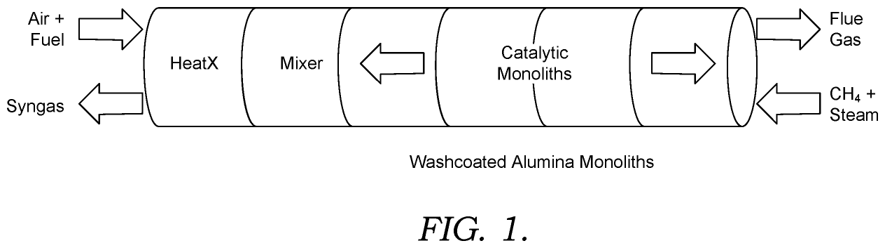

FIG. 1 shows a side view of how monoliths can be stacked in combination with other elements to provide the reactor internals for a counter-current flow reforming reactor. In the example shown in FIG. 1, each element in the stack can represent a single element that fills the entire reactor cross-section, or each element can be representative of a plurality of parallel elements.

In the side view shown in FIG. 1, a stack of reactor internal elements are shown. This stack is shown oriented in a horizontal configuration, but a vertical configuration can also be used, such as a configuration where the recuperator element(s) 110 and mixer element(s) 120 are at the top of the vertical stack. In this discussion, the end including the recuperator element(s) 110 can be referred to as the recuperation side or end of the reactor. The end containing the monoliths 130 can be referred to as the reforming side or end of the reactor.

During operation the recuperator element(s) 110 correspond to the input flow side of the stack for the combustion/heating flows and the output flow side of the stack for the reforming flows. The opposing end (starting with a monolith 130) corresponds to the output flow side of the stack for the combustion/heating flows and the input flow side of the stack for the reforming flows.

In FIG. 1, monolith elements 130 correspond to monoliths that include reforming flow channels and heating flow channels. The reforming flow channels in monolith elements 130 include reforming catalyst. The heating flow channels do not include catalyst. During operation, combustion is performed in the heating flow channels to add heat to the monoliths 130. The heat is transferred to the reforming flow channels to provide heat for the endothermic reforming reaction.

Recuperator element(s) 110 also include channels, but the channels operate somewhat differently. Some flow channels in recuperator element(s) 110 correspond to channels for receiving flows from the reforming channels. Optionally, the reforming flow channels in the recuperator may be the same as the reforming flow channels in the reforming zone, so that the reforming flow channels are continuous from the reforming end of the reactor to the recuperator end of the reactor. However, the portion of the reforming flow channels in recuperator element(s) 110 do not include reforming catalyst. Instead, in the recuperator, the output flow from the reforming reaction is actually at higher temperature than the input flows for the combustion reaction. Thus, heat is passed from the reforming output flow in the reforming flow channels to the input flows for combustion. This allows for pre-heating of the input flows for combustion prior to performing the combustion reaction. It is noted that combustion does not typically occur in the recuperator element(s) 110. Instead, combustion is delayed until the combustion input flows reach the heating flow channels in monoliths 130. This delay in combustion can be achieved, for example, by using a portion of the flow channels to carry fuel for combustion while using another portion of flow channels for oxidant. The fuel and oxidant can then be combined in the heating flow channels in monoliths 130.

The mixer element(s) 120 assist with mixing of the fuel and oxidant prior to passing the combustion input flows in the heating flow channels in monoliths 130. Any convenient type of mixer elements can be used that can assist with substantially uniform distribution of fuel and oxidant into the heating flow channels in monoliths 130. By combining the fuel and oxidant at or near the exit to the mixer element(s) 120, combustion can be initiated at or near the beginning of where the combustion input flows enter the heating flow channels of monoliths 130.

The stack of internal reactor elements shown in FIG. 1 can be housed in any convenient type of reactor. One suitable type of reactor housing can be the housing for a reverse flow reactor, such as the types of reactors described in U.S. Pat. Nos. 7,815,873 and 8,754,276.

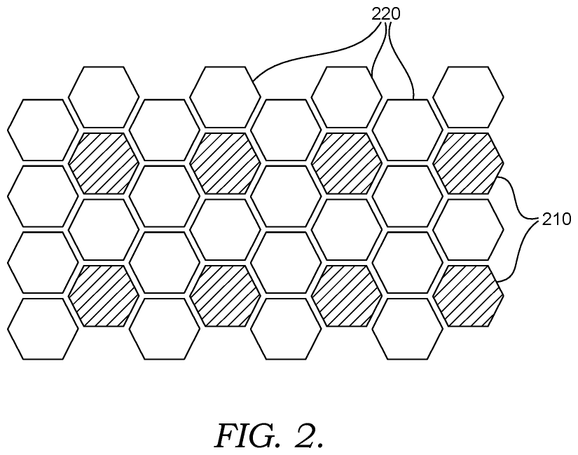

FIG. 2 shows an example of a configuration of hexagonal monoliths with separate monoliths that contain reforming flow channels and heating flow channels. This configuration example illustrates how monoliths can be grouped together to provide monoliths with heating flow channels arranged around the monoliths containing the reforming flow channels. The configuration in FIG. 2 represents a cross-section that is perpendicular to the axis of the channels. In FIG. 2, monoliths 210 correspond to monoliths containing reforming flow channels. Monoliths 220 correspond to monoliths containing heating flow channels. It is noted that due to the relative amounts of heat generated by combustion versus heat consumed by reforming, the flow rate of the input flows for combustion tends to be greater than the flow rate of the input flows for reforming. One way to accommodate the higher flow rate for the combustion input flows is to have a larger number of heating flow channels, as shown in the configuration in FIG. 2. Another option would be to have similar numbers of monoliths for both heating flow channels and reforming flow channels, but to have higher flow rates in the heating flow channels. It is noted that having monoliths with either heating flow channels or reforming flow channels is described for convenience. In other aspects, heating flow channels can be arranged around reforming flow channels for the flow channels within a single monolith.

The flows in the heating flow channels and the reforming flow channels can be maintained as separate in any convenient manner. One option is to use manifolds and/or other fluid connections to keep the flow path for the reforming flow channels separate from the heating flow channels. Additionally or alternately, each monolith or sets of monoliths may be separated by continuous ceramic barriers to reduce cross-leaking, or interlocking monoliths can be used to minimize cross-leaking. At the recuperator end where the combustion input flows enter the stack, a distribution system can be used to route the combustion input flows to the proper monoliths / heating flow channels while the reforming monoliths/reforming flow channels are blinded to these combustion input flows. One example of how this can be done is constructing the top layer(s) of monoliths so that connecting lateral channels (not shown) collect combustion gas flows through the proper exit/inlet. This configuration allows for relatively intimate contact and fast heat transfer between reform and heating streams while still reducing cross-leaking.

One of the purposes of using a monolith or another supporting structure within a reforming environment is to increase the available surface area for holding a deposited catalyst/catalyst system. To achieve this, some monoliths correspond to a structure with a large plurality of cells or channels that allow gas flow through the monolith. Because each individual cell provides surface area for deposition of catalyst, including a large number of cells or channels per unit area can substantially increase the available surface area for catalyst. Similarly, a large number of channels can facilitate higher volume flow rates for combustion gases to provide heat for the endothermic reforming reactions. Such monoliths can generally be referred to as honeycomb monoliths. It is noted that the terms “cell” and “channel” can be used interchangeably to refer to the passages through a monolith.

The monoliths can be fabricated from any convenient material that can withstand a high temperature environment while being substantially non-reactive in the presence of the reforming input flows and combustion input flows. One option is to use a ceramic type monolith, such as a monolith composed of alumina or an alumina alloy. Such monoliths have been used, for example, in reverse flow reactors where the monoliths are exposed to alternating flows of reducing and oxidizing gases in the presence of high temperatures. However, in a counter-current reforming application, any given portion of a monolith will be exposed to either oxidizing flows or reforming flows, so that durability when exposed to alternating combinations of flows is less important. It is further noted that since both the reforming and heating flows are continuous, heat capacity of the monolith material is less important, so long as the monolith material has suitable heat transfer properties. This can expand the options for monolith materials. In some aspects, monoliths with improved heat transfer characteristics can be used, such as metal monoliths, ceramic monoliths with metal coatings, or monoliths including metal-doped alumina, such as copper-doped or titanium-doped alumina.

For ceramic monoliths and/or monoliths including a ceramic portion, in various aspects, a monolith or other structure for providing flow channels for a counter-current reforming system may be prepared by manufacturing techniques such as but not limited to conventional ceramic powder manufacturing and processing techniques, e.g., mixing, milling, degassing, kneading, pressing, extruding, casting, drying, calcining, and sintering. The starting materials can correspond to a suitable ceramic powder and an organic binder powder in a suitable volume ratio. Certain process steps may be controlled or adjusted to obtain the desired grain size and porosity range and performance properties, such as by inclusion of various manufacturing, property adjusting, and processing additives and agents as are generally known in the art. For example, the two or more types of oxide powders may be mixed in the presence of an organic binder and one or more appropriate solvents for a time sufficient to substantially disperse the powders in each other. As another example, precursors of the oxides present in a monolith may be dissolved in water at a desired ratio, spray dried, and calcined to make a mixed powder. Such precursors include (but are not limited to) chlorides, sulfates, nitrates, and mixtures thereof. The calcined powder can be further mixed in the presence of an organic binder and appropriate solvent(s) to make a mixed “dough”. Then, the mixed “dough” of materials can be placed in a die or form, extruded, dried or otherwise formed into a desired shape. The resulting “green body” can then be sintered at temperatures in the range of about 1200° C.˜1700° C. for at least ten minutes, such as from 10 minutes to 10 hours, or possibly from 10 minutes up to 48 hours or still longer.

The sintering operation may be performed in an oxidizing atmosphere, reducing atmosphere, or inert atmosphere, and at ambient pressure or under vacuum. For example, the oxidizing atmosphere could be air or oxygen, the inert atmosphere could be argon, and a reducing atmosphere could be hydrogen, CO/CO₂ or H₂/H₂O mixtures. Thereafter, the sintered body is allowed to cool, typically to ambient conditions. The cooling rate may also be controlled to provide a desired set of grain and pore structures and performance properties in the particular component.

In some aspects, the monoliths can be formed at least in part from alumina. It is noted that after the sintering operation, any alumina present in the monolith will be substantially converted to α-alumina. The “alpha” phase of alumina is thermodynamically favored at high temperatures, and the temperatures during sintering are sufficient convert substantially all of any other phases of alumina into the “alpha” phase. This is beneficial from a stability standpoint, as converting the alumina in the monolith to a-alumina means that phase transitions are not occurring during exposure of the monolith to the cyclic reforming conditions, where the presence of alternative phases of alumina might facilitate crack formation and/or propagation.

The sintered monolith and/or other formed ceramic structure can have any convenient shape suitable for use as a surface for receiving a catalyst or catalyst system. An example of a monolith can be an extruded honeycomb monolith. Honeycomb monoliths can be extruded structures that comprise many (e.g., a plurality, meaning more than one) small gas flow passages or conduits, arranged in parallel fashion with thin walls in between. A small reactor may include a single monolith, while a larger reactor can include a number of monoliths, while a still larger reactor may be substantially filled with an arrangement of many honeycomb monoliths. Each monolith may be formed by extruding monolith blocks with shaped (e.g., square, trigonal, or hexagonal) cross-section and two- or three-dimensionally stacking such blocks above, behind, and beside each other. Monoliths can be attractive as reactor internal structures because they provide high heat transfer capacity with minimum pressure drop.

In some aspects, density, measured by an Archimedes method well-known to the skilled in the art, can be 3.40 gram/cc or more, or 3.50 gram/cc or more, such as up to 4.00 gram/cc or possibly still higher. In some aspects, porosity can be nearly completely closed within the honeycomb monolith walls with the porosity being 10% or less, or 8.0% or less, such as down to 1.0% or possibly still lower.

In some aspects, honeycomb monoliths can be characterized as having open frontal area (or geometric void volume) between 30% to 70%, or 30% to 60%, or 40% to 70%, or 40% to 60%, or 45% to 55%. Additionally or alternately, a monolith can have a conduit density between 50 to 900 cells per square inch (CPSI), or 50 to 600, or 300 to 900, or 300 to 600, or 350 to 550. This roughly corresponds to 7 to 140 cells per square centimeter, or 45 to 140, or 7 to 95, or 45 to 95, or 55 to 85. In some aspects, this type of cell density roughly corresponds to cells or channels that have a diameter/characteristic cell side length of only a few millimeters, such as on the order of roughly one millimeter. Reactor media components, such as the monoliths or alternative bed media, can provide for channels that include a packing with an average wetted surface area per unit volume that ranges from 50 ft⁻¹ to 3000 ft⁻¹ (˜0.16 km⁻¹ to˜10 km⁻¹), or from 100 ft⁻¹ to 2500 ft⁻¹ (˜0.32 km⁻¹ to ˜8.2 km⁻¹), or from 200 ft⁻¹ to 2000 ft⁻¹ (˜0.65 km⁻¹ to ˜6.5 km⁻¹), based upon the volume of the first reactor that is used to convey a reactant. These relatively high surface area per unit volume values can aid in achieving a relatively quick change in the temperature through the reactor.

In some aspects, reactor media components can also provide for channels that include a packing that includes a high volumetric heat transfer coefficient (e.g., 0.02 cal/cm³s ° C. or more, or 0.05 cal/cm³s ° C. or more, or 0.10 cal/cal/cm³s ° C. or more); that have low resistance to flow (low pressure drop); that have an operating temperature range consistent with the highest temperatures encountered during regeneration; that have high resistance to thermal shock; and/or that have high bulk heat capacity (e.g., 0.10 cal/cm³ s ° C. or more, or 0.20 cal/cm³ s ° C. or more). The cited values are averages based upon the volume of reactor used for conveyance of a reactant.

In various aspects, adequate heat transfer rate can be characterized by a heat transfer parameter, ΔTHT, below 500° C., or below 100° C., or below 50° C. The parameter ΔTHT, as used herein, is the ratio of the bed-average volumetric heat transfer rate that is needed for recuperation, to the volumetric heat transfer coefficient of the bed, hv. The volumetric heat transfer rate (e.g. cal/cm³ sec) that is sufficient for recuperation can be calculated as the product of the gas flow rate (e.g. g/sec) with the gas heat capacity (e.g. cal/g ° C.) and desired end-to-end temperature change (excluding any reaction, e.g. ° C.), and then this quantity can be divided by the volume (e.g. cm³) of the reactor (or portion of a reactor) traversed by the gas. The volumetric heat transfer coefficient of the bed, hv, can typically be calculated as the product of an area-based coefficient (e.g. cal/cm² s ° C.) and a specific surface area for heat transfer (av, e.g. cm²/cm³), often referred to as the wetted area of the packing.

### Flow Channel Example—Shell and Tube Configuration

An alternative to using monoliths is to use a shell and tube type configuration. In a shell and tube type configuration, one gas flow is contained within the shell while the other gas flow is contained within the tubes. Typically, the reforming will occur in the tubes, due to the lower volume of the tubes. However, the reforming could be performed in the shell with the heating flow in the tubes if desired.

In this type of alternative configuration, the volume of the reactor that corresponds to monoliths 130 in FIG. 1 instead contains tubes corresponding to the reforming flow channels, while the shell (e.g., the remaining reactor volume) corresponds to the heating flow channels. However, the recuperator element(s) 110 and mixer element(s) 120 are retained. The function of the recuperator element(s) 110 can be maintained in any convenient manner. For example, the tubes containing the reforming catalyst and reforming flow in the shell and tube design can extend through the mixer elements and through the recuperator section. The amount of reforming catalyst in the portion of the tubes that is in the mixing and/or recuperator section can be reduced, minimized, or eliminated, so that the tubes in the mixing and recuperator sections serve primarily to transfer heat back to the incoming flow of combustion input gases. Preferably, there is substantially no catalyst in the portion of the reforming flow tubes that is in the mixer section and/or the recuperation section of the reactor.

The combustion input gases can be maintained separately in the recuperator and mixer sections by any convenient method. One option can be to use separate tubes in the recuperator section to carry the oxidant flow, while the fuel flow is introduced into the shell in the recuperator section. In this type of aspect, the reforming flow in the reforming tubes may primarily serve to heat the fuel prior to combustion. The mixer can then allow the oxidant flow and fuel to mix at or near the interface between the mixer elements and the volume of the shell on the opposing side of the mixer elements, which corresponds to the location where the reforming catalyst density in the reforming tubes starts to become reduced, minimized, or eliminated. In this manner, a temperature profile can be maintained so that the highest temperature in the shell and tube configuration is located at or near the interface between the mixer elements and the reforming tubes, as opposed to having the highest temperature at the end of the reactor.

In order to maintain the start of combustion at a location toward the middle of the shell, a barrier can be included at or near the mixer so that there are separate shell volumes on either side of the mixer. The mixer can then be configured so that the only paths for the fuel to flow from the fuel entry side of the shell to the heating flow exhaust side of the shell is by passing through the mixer. This can assist with both mixing of fuel and oxidant, and with preventing backflow of oxidant toward the end of the shell where the combustion gases are input.

With regard to tube design, the reforming catalyst can be loaded into the tubes in any convenient manner. One option can be to line the interior of the tubes with a refractory material that then serves as a support for reforming catalyst. Another option can be to incorporate monoliths into the tubes, such as a monolith as described herein. Metal tubes with no refractory lining may also be suitable, so long as the metal tubes are suitable for use in the presence of the combustion used for heating the interior of the shell.

In order to facilitate heat transfer into the reforming flow tubes, the diameter of the reforming flow tubes can be roughly 1.0 cm to 8.0 cm, or 1.0 cm to 6.0 cm, or 1.0 cm to 4.0 cm, or 2.0 cm to 8.0 cm, or 2.0 cm to 6.0 cm. To the degree that flow tubes are used for combustion input flows (such as flow tubes to keep oxidant separate from fuel in the recuperator end of the reactor in order to delay combustion until a middle portion of the reactor), similar tube diameters can be used.

### Catalysts and Catalyst Systems

In various aspects, catalysts and/or catalyst systems are provided for reforming of hydrocarbons, along with methods for using such catalysts and/or catalyst systems. The catalysts and/or catalyst systems can be deposited or otherwise coated on a surface or structure, such as a monolith, to achieve improved activity and/or structural stability. In this discussion, a catalyst system is defined to include at least one catalyst corresponding to one or more catalytic metals, optionally in the form of a metal oxide, and at least one metal oxide support layer. In some aspects, the catalyst and metal oxide support layer can be coated on the monolith at the same time, such as in the form of a washcoat layer on the support. In such aspects, the catalyst can be intermixed with the metal oxide support layer. Alternatively, the catalyst and metal oxide support layer can be deposited sequentially so that the support layer is deposited first, followed by the catalyst. In some aspects, the metal oxide support layer can correspond to a thermally stable metal oxide support layer, such as a metal oxide support layer that is thermally phase stable at temperatures of 800° C. to 1600° C. Optionally, an intermediate bonding layer can be applied to at least a portion of the monolith or other structure prior to depositing the catalyst system. The catalyst systems can be beneficial for use in cyclical reaction environments, such as reverse flow reactors or other types of reactors that are operated using flows in opposing directions and different times within a reaction cycle. The reaction conditions in cyclical reaction environments can also undergo swings in temperature and/or pressure during a reaction cycle. In still other aspects, a catalyst can be deposited without using a corresponding metal oxide support layer.

In some aspects, the catalyst or catalyst system can correspond to one or more catalysts in a single zone. In other aspects, the catalyst or catalyst system can correspond to a plurality of catalyst zones. Optionally in such aspects, at least one catalyst zone can include a catalyst that is different from the catalyst(s) in a second catalyst zone.

In some aspects, the catalyst system can include a thermally stable metal oxide support layer. A thermally stable metal oxide support layer corresponds to a metal oxide that is thermally phase stable with regard to structural phase changes at temperatures between 800° C. to 1600° C. In some aspects, such a thermally stable metal oxide support layer can be formed by coating a surface (such using a washcoat) with a metal oxide powder that has a surface area of 20 m²/g or less. For example, the metal oxide powder used for forming a thermally stable metal oxide coating can have a surface area of 0.5 m²/g to 20 m²/g, or 1.0 m²/g to 20 m²/g, or 5.0 m²/g to 20 m²/g. High temperature reforming refers to reforming that takes place at a reforming temperature of 1000° C. or more, or 1100° C. or more, or 1200° C. or more, such as up to 1500° C. or possibly still higher. In various aspects, a catalyst can be annealed at a temperature of 1000° C. or more, or 1100° C. or more, or 1200° C. or more, or 1300° C. or more, such as up to 1600° C. or possibly still higher. This temperature can be substantially similar to or greater than the peak temperature the catalyst is exposed to during a reforming process cycle. An annealing temperature that is substantially similar to a peak temperature can correspond to an annealing temperature that differs from the peak temperature by 0° C. to 50° C.

As an example of a thermally stable metal oxide support layer, alumina has a variety of phases, including α-Al₂O₃, γ-Al₂O₃, and θ-Al₂O₃. A metal powder of α-Al₂O₃ can typically have a surface area of 20 m²/g or less. By contrast, the γ-Al₂O₃ and θ-Al₂O₃ phases have higher surface areas, and a metal powder for use in a washcoat solution of γ-Al₂O₃ and/or θ-Al₂O₃ will have a surface area of greater than 20 m²/g. It is conventionally believed that phases such as θ-alumina or γ-alumina are superior as a supporting structure for a deposited catalyst, as the greater surface per gram of θ-alumina or γ-alumina will allow for availability of more catalyst active sites than a-alumina. However, phases such as γ-Al₂O₃ and θ-Al₂O₃ are not thermally phase stable at temperatures of 800° C. to 1600° C. At such high temperatures, phases such as γ-Al₂O₃ and θ-Al₂O₃ will undergo phase transitions to higher stability phases. For example, at elevated temperatures, γ-Al₂O₃ will first convert to Δ-Al₂O₃ at roughly 750° C.; then Δ-Al₂O₃ will convert to θ-Al₂O₃ at roughly 950° C.; then θ-Al₂O₃ will then convert to α-Al₂O₃ with further exposure to elevated temperatures between 1000° C. and 1100° C. Thus, α-Al₂O₃ is the thermally phase stable version of Al₂O₃ at temperatures of 800° C. to 1600° C.

In various aspects, one option for adding a catalyst or catalyst system to a monolith can be to coat the monolith with a mixture of a catalyst (optionally in oxide form) and optionally a metal oxide support layer. For example, powders of the catalyst oxide and/or the metal oxide support layer can be used to form a washcoat that is then applied to the monolith (or other structure). In some aspects, this can result in a catalyst system where the catalyst is mixed within/distributed the metal oxide support layer, as opposed to the catalyst being deposited on top of the metal oxide support layer. In such aspects, at least a portion of the catalyst system can correspond to a mixture of the catalyst and the support layer. In other aspects, any convenient method for depositing or otherwise coating a catalyst and/or catalyst system on the monolith or other structure can be used. The weight of the catalyst and/or catalyst system on the monolith (or other structure) can correspond to 0.1 wt % to 10 wt % of the total weight of the catalyst system plus monolith, or 0.5 wt % to 10 wt %, or 2.0 wt % to 10 wt %, or 0.1 wt % to 6.0 wt %, or 0.5 wt % to 6.0 wt %, or 2.0 wt % to 6.0 wt %.

A catalyst and/or catalyst system can be applied to a monolith or other structure, for example, by applying the catalyst system as a washcoat suspension. To form a washcoat suspension, the catalyst and/or catalyst system can be added to water to form an aqueous suspension having 10 wt % to 50 wt % solids. For example, the aqueous suspension can include 10 wt % to 50 wt % solids, or 15 wt % to 40 wt %, or 10 wt % to 30 wt %. Optionally, an acid or a base can be added to the aqueous suspension to reduce or raise, respectively, the pH so as to change the particle size distribution of the alumina catalyst and/or binder particles. For example, acetic acid or another organic acid can be added to achieve a pH of 3 to 4. The suspension can then be ball milled (or processed in another manner) to achieve a desired particle size for the catalyst particles, such as a particle size of 0.5 μm to 5 μm. After milling, the suspension can be stirred until time for use so that the particles are distributed substantially uniformly in the solution.

The washcoat suspension can then be applied to a monolith structure to achieve a desired amount of catalyst (such as nickel or rhodium) on the monolith surface. As an example, in one aspect a washcoat thickness of 10 microns was achieved by forming a washcoat corresponding to 10 wt % of the monolith structure. Any convenient type of monolith structure can be used to provide a substantial surface area for support of the catalyst particles. The washcoat can be applied to the monolith to form cells having inner surfaces coated with the catalyst. One option for applying the washcoat can be to dip or otherwise submerge the monolith in the washcoat suspension.

After clearing the cell channels of excess washcoat, the catalyst system coated on the monolith can be optionally dried. Drying can correspond to heating at 100° C. to 200° C. for 0.5 hours to 24 hours. After any optional drying, calcination can be performed. In some aspects, calcining can correspond to heating at 200° C. to 800° C. for 0.5 hours to 24 hours.

In other aspects, a high temperature calcination step can be used, so that the calcining temperature for the catalyst system coated on the monolith is substantially similar to or greater than the peak temperature the monolith will be exposed to during the cyclic high temperature reforming reaction. For a monolith in a high temperature zone, this can correspond to calcining the catalyst system coated on the monolith at a temperature of 800° C. or more, or 1000° C. or more, or 1200° C. or more, or 1300° C. or more, such as up to 1600° C. or possibly still higher. It is noted that if multiple catalyst zones are present, the calcination for monoliths in different catalyst zones can be different.

It has been unexpectedly discovered that performing calcination at a temperature similar to or greater than the peak temperature during the cyclic high temperature reforming process can unexpectedly allow for improved activity for the catalyst system and/or adhesion of the catalyst system to the underlying monolith. Without being bound by any particular theory, it is believed that exposing the monolith and deposited catalyst system to elevated temperatures prior to exposure of the catalyst to a cyclic reaction environment can facilitate forming a stable interface between the catalyst system and the monolith. This stable interface can then have improved resistance to the high temperature oxidizing and/or reducing environment during the reforming process, resulting in improved stability for maintaining the catalyst system on the surface of the monolith.

One of the distinctions between using a catalyst system including a thermally stable metal oxide and a catalyst system that does not use a thermally stable oxide is that the catalyst system including the thermally stable metal oxide can have improved adhesion to the underlying support structure after exposure to the cyclic high temperature reforming environment.

In various aspects, suitable catalytic metals can include, but are not limited to, Ni, Co, Fe, Pd, Rh, Ru, Pt, Ir, Cu, Ag, Au, Zr, Cr, Ti, V, Mo, Nb, and combinations thereof. The catalytic metal can be selected based on the desired type of catalytic activity. Such catalytic metals may be used in a catalyst in the form of a metal oxide. In some aspects, for reforming of hydrocarbons in the presence of H₂O and/or CO₂ to make hydrogen, Ni, Rh, Ru, Pd, Pt, Ir, Cu, Co, or a combination of thereof can be suitable catalytic metals. The weight of catalytic metal oxide in the catalyst system can range from 0.1 wt % to 70 wt %, or 1.0 wt % to 60 wt %, or 2.0 wt % to 50 wt %, relative to the total weight of the catalyst system. In some aspects where the catalytic metal corresponds to a precious metal or noble metal, the weight of catalytic metal oxide in the catalyst system can range from 0.1 wt % to 10 wt %, or 0.2 wt % to 7.0 wt %, or 0.5 wt % to 4 wt %.

The catalytic metals can be selected to provide long term stable performance at specific temperature zones of the catalytic bed. This can allow for steady methane conversion, phase stability with the metal oxide support, and reduced or minimized sintering of catalytic metals. As an example involving three catalyst zones, the catalyst system in a highest temperature catalytic zone (e.g. 800-1250° C.), which is exposed to some of highest temperatures and most severe temperature swings, can be composed of Ni as a catalytic metal (NiO as a catalytic metal oxide) and Al₂O₃ as a metal oxide support. This catalyst system can be formed, for example, by using a mixture of NiO and Al₂O₃ , as a washcoat on a-Al₂O₃ monoliths. In such an example, a catalyst system in a medium temperature catalytic zone (e.g. 600-1150° C.) can be composed of Ni and Rh as catalytic metals (NiO and Rh₂O₃ as catalytic metal oxide), and Al₂O₃ as a metal oxide support. To form this catalyst system, a mixture of NiO and Rh₂O₃, as the catalytic material and Al₂O₃ (optionally but preferably α-Al₂O₃) as a metal oxide support material can be washcoated on a monolith comprising of 95 wt % α-Al₂O₃, 4 wt % SiO₂ and 1 wt % TiO₂. In such an example, a catalyst system in a low temperature catalytic zone (e.g. 400-1050° C.) can be composed of Rh as catalytic metal (Rh₂O₃ as catalytic metal oxide) and α-Al₂O₃ as a metal oxide support. To form this catalyst system, a mixture of Rh₂O₃ and α-Al₂O₃ as the catalytic material can be washcoated on a monolith comprising 93 wt % α-Al₂O₃, 5 wt % SiO₂ and 2 wt % MgO.

In various aspects, suitable metals for the metal oxide support layer in the catalyst system can include, but are not limited to, Al, Si, Mg, Ca, Sr, Ba, K, Na, Ti, Zr, Hf, V, Nb, Ta, Cr, Mo, W, Mn, Fe, Ni, Co, Y, La, Ce, and combinations thereof. The metal (or metals) for the metal oxide support can be selected so that the metal oxide support substantially does not convert to metallic form under the reducing conditions present in the cyclic reaction environment. As an example, when the catalytic metal oxide is NiO, one option for a metal oxide support is Al₂O₃ , preferably α-Al₂O₃. Another example of a suitable metal oxide support, optionally, in combination with NiO as the catalytic metal oxide, is a mixture of Al₂O₃ with SiO₂, MgO and/or TiO₂. In such an example, SiO₂ can combine with Al₂O₃ to form a mullite phase that could increase resistance to thermal shock and/or mechanical failure. Additionally or alternately, in such an example, MgO and/or TiO₂ can be added. The weight of metal oxide support in the catalyst bed can range from 1.0 wt % to 40 wt %, or 2.0 wt % to 30 wt %, or 3.0 wt % to 20 wt %, relative to the total weight of the monolith in the catalyst bed.

In various aspects, a metal oxide support layer (such as a thermally stable metal oxide support layer) can correspond to at least one oxide selected from the corundum group, stabilized zirconia, perovskite, pyrochlore, spinel, hibonite, zeolite, and mixtures thereof. The weight of metal oxide support can range from 1.0 wt % to 40 wt %, or 2.0 wt % to 30 wt %, or 3.0 wt % to 20 wt %, relative to the total weight of the monolith plus catalyst system.

One category of metal oxide support layers can correspond to traditional refractory oxides that are commonly used to form supported catalysts. For example, the metal oxide support can correspond to α-Al₂O₃, LaAlO₃, LaAl₁₁O₁₈, MgO, CaO, ZrO₂, TiO₂, CeO₂, Y₂O₃, La₂O₃, SiO₂, Na₂O, K₂O, and mixtures thereof. This group is defined herein as the “corundum” group of oxides, although many of the oxides in this group do not have the corundum lattice structure. For example, CeO₂ and MgO can both have a halite crystal structure. α-Al₂O₃ consists essentially of a dense arrangement of oxygen ions in hexagonal closest-packing with Al³⁺ ions in two-thirds of the available octahedral sites. LaAlO₃, often abbreviated as LAO, is an optically transparent ceramic oxide with a distorted perovskite structure. LaAl₁₁O₁₈ can be formed through the solid state reaction of LaAlO₃ and α-Al₂O₃. Plate-like crystals of LaAl₁₁O₁₈ are particularly useful as a metal oxide support since catalytic metals can be trapped between plate-like crystal structures. It suppresses sintering of minute catalytic metals in the active material which is washcoated on the monolith of the catalyst bed. Additional examples of oxides from the corundum group can include, but are not limited to: i) 95 wt % α-Al₂O₃ and 5 wt % SiO₂; ii) 93 wt % α-Al₂O₃, 5 wt % SiO₂ and 2 wt % MgO; iii) 94 wt % α-Al₂O₃, 4 wt % SiO₂, 2 wt % MgO and 1 wt % Na₂O; iv) 95 wt % α-Al₂O₃, 4 wt % SiO₂ and 1 wt % TiO₂; v) 7 wt % CeO₂ and 93 wt % MgO; vi) 5 wt % CaO and 95 wt % α-Al₂O₃; vii) 5 wt % MgO, 5 wt % CeO₂ and 90 wt % α-Al₂O₃; viii) 20 wt % ZrO₂ and 80 wt % CeO₂, ix) 5 wt % CeO₂, 20 wt % ZrO₂ and 75 wt % α-Al₂O₃, and x) 6 wt % La₂O₃ and 94 wt % α-Al₂O₃, based on the weight of metal oxide support.

### Process Example—Reforming and Heating

In various aspects, reforming of hydrocarbons can be performed under steam reforming conditions in the presence of H₂O, under dry reforming conditions in the presence of CO₂, or under conditions where both H₂O and CO₂ are present in the reaction environment. As a general overview of operation of reforming in a counter-current reactor, the heat for performing the reforming reaction is provided by performing heating in heating flow tubes or a heating flow volume. The heat is provided, for example, by performing combustion at a combustion location with the heating flow tubes or heating flow volume. The heat from combustion is then carried downstream in the heating flow tubes or heating flow volume by the gas flow of combustion products and/or any carrier gases (such as N₂) that are present in the combustion input flow. Reforming can then occur within the reforming flow tubes, with the reforming reaction consuming heat provided by the heating flow tubes and/or heating volume.

During operation of a counter-current reforming reactor, fuel and an oxidant are introduced into the reactor from a heating end of the reactor. The recuperator portion of the reactor can absorb heat, but typically does not include a catalyst for reforming. As the fuel and oxidant pass through the recuperation section, heat is transferred from the recuperation section to at least one of the fuel and oxidant. Combustion does not occur immediately, but instead the location of combustion is controlled to occur in a middle portion of the reactor. The flow of the reactants continues after combustion, leading to additional transfer of the heat generated from combustion into the reforming end of the reactor.

The reactants for reforming can be introduced into the reforming end of the reactor, and thus flow in effectively the opposite direction relative to the heating flow. The bed and/or monoliths in the reforming portion of the reactor can include a catalyst for reforming. In various aspects, at least a portion of the catalyst can correspond to a catalyst formed from a ceramic composition as described herein. As reforming occurs, the heat introduced into the reforming flow channels by heat transfer from the heating flow channels can be consumed by the endothermic reforming reaction. After exiting the reforming zone, the reforming products (and unreacted reactants) are optionally but preferably no longer exposed to a reforming catalyst. As the reforming products pass through the recuperation zone, heat can be transferred from the products to the heating flow channels in the recuperation zone.

The reforming reaction performed within the reactor can correspond reforming of methane and/or other hydrocarbons using steam reforming, in the presence of H₂O; using dry reforming, in the presence of CO₂, or using “bi” reforming in the presence of both H₂O and CO₂. Examples of stoichiometry for steam, dry, and “bi” reforming of methane are shown in equations (1)-(3).

Dry Reforming: CH₄+CO₂=2CO+2H₂ (1)

Steam Reforming: CH₄+H₂O=CO+3H₂ (2)

Bi Reforming: 3CH₄+2H₂O+CO₂=4CO+8H₂. (3)

As shown in equations (1)-(3), dry reforming can produce lower ratios of H₂ to CO than steam reforming. Reforming reactions performed with only steam can generally produce a ratio of H₂ to CO of around 3, such as 2.5 to 3.5. By contrast, reforming reactions performed in the presence of CO₂ can generate much lower ratios, possibly approaching a ratio of H₂ to CO of roughly 1.0 or even lower. By using a combination of CO₂ and H₂O during reforming, the reforming reaction can potentially be controlled to generate a wide variety of H₂ to CO ratios in a resulting syngas.

It is noted that the ratio of H₂ to CO in a synthesis gas can also be dependent on the water gas shift equilibrium. Although the above stoichiometry shows ratios of roughly 1 or roughly 3 for dry reforming and steam reforming, respectively, the equilibrium amounts of H₂ and CO in a synthesis gas can be different from the reaction stoichiometry. The equilibrium amounts can be determined based on the water gas shift equilibrium, which relates the concentrations of H₂, CO, CO₂ and H₂O based on the reaction

H₂O+CO<=>H₂+CO₂ (4)

Most reforming catalysts, such as rhodium and/or nickel, can also serve as water gas shift catalysts. Thus, if reaction environment for producing H₂ and CO also includes H₂O and/or CO₂, the initial stoichiometry from the reforming reaction may be altered based on the water gas shift equilibrium. This equilibrium is also temperature dependent, with higher temperatures favoring production of CO and H₂O. It is noted that higher temperatures can also improve the rate for reaching equilibrium. As a result, the ability to perform a reforming reaction at elevated temperatures can potentially provide several benefits. For example, instead of performing steam reforming in an environment with excess H₂O, CO₂ can be added to the reaction environment. This can allow for both a reduction in the ratio of H₂ to CO produced based on the dry reforming stoichiometry as well as a reduction in the ratio of H₂ to CO produced based on the water gas shift equilibrium. Alternatively, if a higher H₂ to CO ratio is desired, CO₂ can be removed from the environment, and the ratio of H₂O to CH₄ (or other hydrocarbons) can be controlled to produce a desirable type of synthesis gas. This can potentially allow for generation of a synthesis gas having a H₂ to CO ratio of 0.1 to 15, or 0.1 to 3.0, or 0.5 to 5.0, or 1.0 to 10, by selecting appropriate amounts of feed components.

One common source for methane is natural gas. In some applications, natural gas, including associated hydrocarbon and impurity gases, may be used as a feed for the reforming reaction. The supplied natural gas also may be sweetened and/or dehydrated natural gas. Natural gas commonly includes various concentrations of associated gases, such as ethane and other alkanes, preferably in lesser concentrations than methane. The supplied natural gas may include impurities, such as H₂S and nitrogen. More generally, the hydrocarbon feed for reforming can include any convenient combination of methane and/or other hydrocarbons. Optionally, the reforming feed may also include some hydrocarbonaceous compounds, such as alcohols or mercaptans, which are similar to hydrocarbons but include one or more heteroatoms different from carbon and hydrogen. In some aspects, an additional component present in the feed can correspond to impurities such as sulfur that can adsorb to the catalytic monolith during a reducing cycle (such as a reforming cycle). Such impurities can be oxidized in a subsequent cycle to form sulfur oxides, which can then be reduced to release additional sulfur-containing components (or other impurity-containing components) into the reaction environment.

In some aspects, the feed for reforming can include, relative to a total weight of hydrocarbons in the feed for reforming, 5 wt % or more of C₂₊ compounds, such as ethane or propane, or 10 wt % or more, or 15 wt % or more, or 20 wt % or more, such as up to 50 wt % or possibly still higher. It is noted that nitrogen and/or other gases that are non-reactive in a combustion environment, such as H₂O and CO₂, may also be present in the feed for reforming. In aspects where the reformer corresponds to an on-board reforming environment, such non-reactive products can optionally be introduced into the feed, for example, based on recycle of an exhaust gas into the reformer. Additionally or alternately, the feed for reforming can include 40 wt % or more methane, or 60 wt % or more, or 80 wt % or more, or 95 wt % or more, such as having a feed that is substantially composed of methane (98 wt % or more). In aspects where the reforming corresponds to steam reforming, a molar ratio of steam molecules to carbon atoms in the feed can be 0.3 to 4.0. It is noted that methane has 1 carbon atom per molecule while ethane has 2 carbon atoms per molecule. In aspects where the reforming corresponds to dry reforming, a molar ratio of CO₂ molecules to carbon atoms in the feed can be 0.05 to 3.0.

Within the reforming zone of a reverse flow reactor, the temperature can vary across the zone due to the nature of how heat is added to the reactor and/or due to the kinetics of the reforming reaction. The highest temperature portion of the zone can typically be found near a middle portion of the reactor, such as at or near the interface between the reforming flow channels and the mixer element(s). At least a portion of the mixing zone can correspond to part of the reforming zone if a monolith with reforming catalyst extends into the mixing zone. As a result, the location where combustion is started during regeneration can typically be near to the end of the reforming zone within the reactor. Moving from the center of the reactor (and/or from the location of highest temperature) to the ends of the reactor, the temperature can decrease. As a result, the temperature at the beginning of the reforming zone (at the end of the reactor) can be cooler than the temperature at the end of the reforming zone (in a middle portion of the reactor).

To produce heat in the heating flow channels, a fuel such as methane, natural gas, or H₂, and oxygen can be introduced into the reactor and combusted. The location where the fuel and oxidant are allowed to mix can be controlled in any convenient manner, such as by introducing the fuel and oxidant via separate channels. By delaying combustion until the reactants reach a central portion of the reactor, the non-reforming end of the reactor can be maintained at a cooler temperature. This can also result in a temperature peak in a middle portion of the reactor. Optionally, the temperature peak can be located within a portion of the reactor that also includes the reforming catalyst.

Because heat is being transferred from the heating flow channels (and/or heating flow volume) to the reforming flow channels, the peak temperatures can be different in the two different types of flow channels. In the heating flow channels, the peak temperature can be 1100° C. or more, or 1200° C. or more, or 1300° C. or more, or potentially a still higher temperature, such as up to 1500° C. or possibly still higher. In the reforming flow channels, the peak temperature can be 750° C. to 1200° C., or 750° C. to 1100° C., or 750° C. to 1000° C., or 850° C. to 1200° C., or 850° C. to 1100° C., or 950° C. to 1200° C. It is noted that reforming is reduced or minimized at temperatures below roughly 500° C. In some aspects, the peak temperature in the reforming channels can be sufficiently high so that the temperature at the end of the reforming channel remains above 500° C.

In various aspects, the reaction conditions for reforming hydrocarbons can include one or more of an average reforming zone temperature ranging from 400° C. to 1000° C., or 400° C. to 800° C., or 500° C. to 1000° C., or 500° C. to 800° C., or 600° C. to 1000° C.; a peak temperature within the reforming zone / within the reforming flow channels of 750° C. to 1200° C., or 750° C. to 1100° C., or 750° C. to 1000° C., or 850° C. to 1200° C., or 850° C. to 1100° C., or 950° C. to 1200° C.; and a difference between the temperature in the reforming flow channels at the end of the recuperation zone and the peak temperature in the reforming flow channels of 100° C. to 800° C., or 100° C. to 600° C., or 100° C. to 400° C., or 200° C. to 800° C., or 200° C. to 600° C. Optionally, the difference between the peak temperature in the reforming flow channels and the temperature in the reforming flow channels at the end of the reforming zone (where the reforming input flow enters the reactor) can be 50° C. to 500° C., or 100° C. to 500° C., or 50° C. to 300° C., or 100° C. to 300° C.

Additionally or alternately, the reaction conditions for reforming hydrocarbons can include a pressure of 0 psig to 1500 psig (10.3 MPa), or 0 psig to 1000 psig (6.9 MPa), or 0 psig to 550 psig (3.8 MPa); and a gas hourly space velocity of reforming reactants of 1000 hr⁻¹ to 50,000 hr⁻¹. The space velocity corresponds to the volume of reactants relative to the volume of monolith per unit time. The volume of the monolith is defined as the volume of the monolith as if it was a solid cylinder.

In some aspects, an advantage of operating the reforming reaction at elevated temperature can be the ability to convert substantially all of the methane and/or other hydrocarbons in a reforming feed. For example, for a reforming process where water is present in the reforming reaction environment (i.e., steam reforming or bi-reforming), the reaction conditions can be suitable for conversion of 10 wt % to 100 wt % of the methane in the reforming feed, or 20 wt % to 80 wt %, or 50 wt % to 100 wt %, or 80 wt % to 100 wt %, or 10 wt % to 98 wt %, or 50 wt % to 98 wt %. Additionally or alternately, the reaction conditions can be suitable for conversion of 10 wt % to 100 wt % of the hydrocarbons in the reforming feed, or 20 wt % to 80 wt %, or 50 wt % to 100 wt %, or 80 wt % to 100 wt %, or 10 wt % to 98 wt %, or 50 wt % to 98 wt %

In other aspects, for a reforming process where carbon dioxide is present in the reforming reaction environment (i.e., dry reforming or bi-reforming), the reaction conditions can be suitable for conversion of 10 wt % to 100 wt % of the methane in the reforming feed, or 20 wt % to 80 wt %, or 50 wt % to 100 wt %, or 80 wt % to 100 wt %, or 10 wt % to 98 wt %, or 50 wt % to 98 wt %. Additionally or alternately, the reaction conditions can be suitable for conversion of 10 wt % to 100 wt % of the hydrocarbons in the reforming feed, or 20 wt % to 80 wt %, or 50 wt % to 100 wt %, or 80 wt % to 100 wt %, or 10 wt % to 98 wt %, or 50 wt % to 98 wt %.

In some alternative aspects, the reforming reaction can be performed under dry reforming conditions, where the reforming is performed with CO₂ as a reagent but with a reduced or minimized amount of H₂O in the reaction environment. In such alternative aspects, a goal of the reforming reaction can be to produce a synthesis gas with a H₂ to CO ratio of 1.0 or less. In some aspects, the temperature during reforming can correspond to the temperature ranges described for steam reforming. Optionally, in some aspects a dry reforming reaction can be performed at a lower temperature of between 500° C. to 700° C., or 500° C. to 600° C. In such aspects, the ratio of H₂ to CO can be 0.3 to 1.0, or 0.3 to 0.7, or 0.5 to 1.0. Performing the dry reforming reaction under these conditions can also lead to substantial coke production, which can require removal during regeneration in order to maintain catalytic activity.

### Alternative Process Example—Partial Oxidation for Heating

In some alternative aspects, reforming can be performed in both the reforming flow channels and the heating flow channels. This can be accomplished by operating the heating flow channels under partial oxidation conditions.

During partial oxidation, hydrocarbons are exposed to combustion conditions, but less than the stoichiometric amount of oxygen is provided to the reaction environment. As a result, instead of forming primarily CO₂ and H₂O, the sub-stoichiometric amount of O₂ present under partial oxidation conditions results in formation of a mixture of CO₂, CO, H₂, and H₂O. Hydrocarbon reforming based on partial oxidation typically generates a relatively low molar ratio of H₂ to CO, such as a molar ratio of roughly 1.4 to 1.7. Optionally, the partial oxidation products can be exposed to water gas shift reaction conditions to form additional H₂ from a portion of the CO and H₂O present in the partial oxidation products.

It is noted that partial oxidation generally results in generation of less heat per mole of hydrocarbon in the input flow, due to the fact that a much less exothermic product (CO) is formed from at least a portion of the fuel. As a result, operating at partial oxidation conditions can involve increasing the relative flow rate of the heating flow inputs, so that sufficient heat is generated under the partial oxidation conditions to maintain a target amount of reforming in the reforming flow channels.

In some alternative aspects, the ratio of H₂ to CO in the partial oxidation products can be further increased by including a limited amount of reforming catalyst in the heating flow channels. It is noted that the amount of reforming catalyst in the heating flow channels is constrained by the fact that the heating flow channels also need to provide the heat for the reforming reaction in the reforming flow channels. Typically, this will mean that the amount of reforming catalyst in the heating flow channels will be small relative to the amount of catalyst in the reforming flow channels. The relative amounts of reforming catalyst in the heating flow channels versus the reforming flow channels can be determined, for example, by comparing the total weight of catalyst in the heating flow channels versus the total weight of reforming catalyst in the reforming flow channels. This can be calculated, for example, by multiplying the average catalyst density in a type of flow channels with the surface area covered by that average catalyst density. In some aspects, the total weight of reforming catalyst in the heating flow channels can be 25% or less of the total weight of reforming catalyst in the reforming flow channels, or 15% or less, or 10% or less, or 5.0% or less of the total weight, or 3.0% or less of the total weight, such as down to 0.1% of the total weight or possibly still less. In aspects where the reforming catalyst is provided in the form of a catalyst system, this comparison is made based on the weight of the catalyst system in the heating flow channels and the reforming flow channels. It is noted that the catalyst in the heating flow channels may be different from the catalyst in the reforming flow channels. This total weight comparison can still be made, even if the reforming catalysts/catalyst systems differ between the heating flow channels and reforming flow channels.

By incorporating a limited amount of reforming catalyst in the heating flow tubes, the molar ratio of H₂ to CO in the heating flow output can be increased from a typical POx value of roughly 1.4 to 1.7 to a higher amount of 1.8 to 2.1.

In some aspects, one strategy for incorporating the reforming catalyst can be to incorporate the limited amount of reforming catalyst at a location downstream from the location where the partial oxidation reaction is initiated. As an example, in FIG. 1, a series of 5 monoliths are shown as part of the reactor internals, in addition to the mixing and recuperator sections. In this example, reforming catalyst could be included in the heating flow channels of only the second monolith from the left. This would allow the reforming catalyst in the heating flow channels to be offset from the mixer/monolith interface where the partial oxidation will start (due to the delay of mixing of the fuel and oxidant until roughly that location). Thus, the reforming catalyst will not be in the region of highest temperature. This location for the reforming catalyst means that the reforming catalyst in the heating flow channels is still relatively far from the end of the reactor, so that the reforming catalyst is not present in the cooler section of the reactor. This avoids the situation where the reforming catalyst reduces the ratio of H₂ to CO based on water gas shift activity under lower temperature conditions.

In some aspects, in order to assist with having hydrocarbons available for reforming by the reforming catalyst, additional fuel can be introduced into the reactor at or near the downstream location where the reforming catalyst is located in the heating flow channels. The partial oxidation conditions will create H₂O and CO₂, so by adding additional fuel at or near the location where the reforming catalyst is located in the heating flow channels, the amount of hydrocarbon available downstream from the initiation of the POx reactions can be increased.

In still other aspects, the reforming catalyst could be located closer to the mixer/monolith interface, so that the reforming catalyst in the heating flow channels is present at or near the location where the partial oxidation reaction begins in the reactor. In this type of aspect, the reforming reactions compete directly and/or complement the partial oxidation reactions occurring at or near the mixer interface.

### Example—Temperature Profiles During Counter-Current Reforming

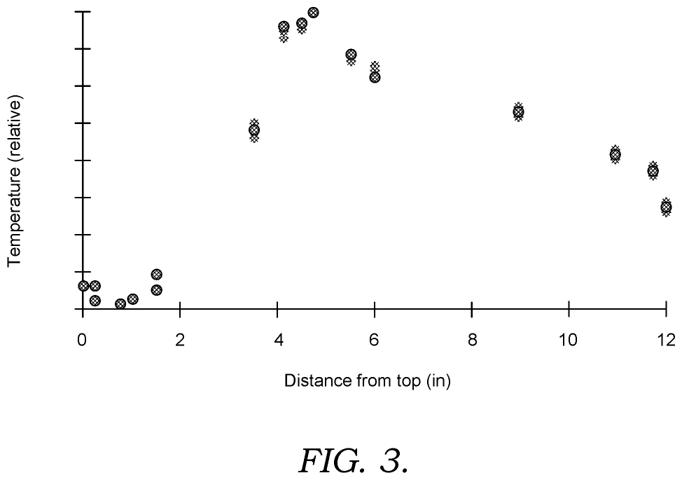

FIG. 3 shows an example of a temperature profile within the reforming flow channels/tubes during counter-current reforming. The temperature profile can also be representative of the temperature within the heating flow channels tubes. Temperature values are not provided on the vertical axis in FIG. 3, as the temperature values will vary depending on the selected peak temperature, the flow rates within the various flow channels/tubes, and based on other factors.

The temperature profile in FIG. 3 corresponds to a profile for a pilot scale reactor with a size of 12 inches. The interface between the mixer element and the monoliths/reforming flow tubes is at 4 inches. This corresponds to the location where fuel and oxidant are allowed to mix during operation, and therefore this is where the peak temperature occurs. The temperature toward the recuperator end of the reactor falls off sharply from the peak temperature. This is because the only heat being carried toward the recuperator end of the reactor is the heat carried by the reforming flow products. By contrast, the heat from the combustion reaction is carried toward the reforming end by the higher volume combustion flow, resulting in higher temperatures for a larger portion of the reforming zone.

In some aspects, the peak temperature for the heating flow channels/tubes can be 1100° C. or more, or 1200° C. or more, such as up to 1500° C. or possibly still higher. In some aspects, the peak temperature for the reforming flow channels can be 750° C. to 1200° C., or 750° C. to 1100° C., or 750° C. to 1000° C., or 850° C. to 1200° C., or 850° C. to 1100° C., or 950° C. to 1200° C. In some aspects, the difference between the peak temperature in the reforming flow channels and the temperature in the reforming flow channels at the recuperation end can be 100° C. to 800° C., or 100° C. to 600° C., or 100° C. to 400° C., or 200° C. to 800° C., or 200° C. to 600° C. In some aspects, the difference between the peak temperature in the reforming flow channels and the temperature in the reforming flow channels at the end of the reforming zone (i.e., where the reforming input flows enter the reactor) can be 50° C. to 500° C., or 100° C. to 500° C., or 50° C. to 300° C., or 100° C. to 300° C.

### Additional Embodiments

Embodiment 1. A method for performing counter-current reforming, comprising: passing a fuel into a fuel flow path and an oxygen-containing gas into an oxidant flow path in a recuperation zone of a reactor volume; passing a reforming input flow comprising at least one hydrocarbon into a plurality of reforming flow channels in a reforming zone of the reactor volume, a flow direction of the reforming input flow being substantially counter-current to a flow direction of at least one of the fuel and the oxygen-containing gas, the reforming channels comprising a reforming catalyst in the reforming zone; mixing the fuel and the oxygen-containing gas in one or more heating flow channels of a mixing zone of the reactor volume to form a fuel mixture, the mixing zone being adjacent to the recuperation zone, an opposing side of the mixing zone being adjacent to the reforming zone; reacting the mixture in the one or more heating flow channels in at least one of the mixing zone and the reforming zone to generate heat and an oxidized product flow, the one or more heating flow channels being arranged around the plurality of reforming flow channels; reforming at least a portion of the at least one hydrocarbon in the reforming channels under reforming conditions to form a reforming product flow; exhausting the reforming product flow from the recuperation zone; and exhausting the oxidized product flow from the reforming zone.

Embodiment 2. The method of Embodiment 1, wherein a peak temperature in the reforming flow channels is greater than a temperature in the reforming flow channels at an end of the recuperator zone by 200° C. or more.

Embodiment 3. The method of Embodiment 1 or 2, wherein a peak temperature in the reforming flow channels is greater than a temperature in the reforming flow channels at an end of the reforming zone by 50° C. or more.

Embodiment 4. The method of any of the above embodiments, wherein the plurality of reforming flow channels comprise a plurality of channels in one or more monoliths.

Embodiment 5. The method of Embodiment 4, wherein the one or more heating flow channels comprise a plurality of channels in the one or more monoliths; or wherein the reforming zone comprises a plurality of first monoliths and a plurality of second monoliths, the plurality of first monoliths comprising the plurality of reforming flow channels, the plurality of second monoliths comprising the plurality of heating flow channels; or a combination thereof.

Embodiment 6. The method of any of the above embodiments, wherein the fuel flow path and the oxidant flow path comprise channels in one or more recuperator monoliths.

Embodiment 7. The method of any of Embodiment 1-3, wherein the plurality of reforming flow channels comprise a plurality of tubes, the reactor volume comprising a reactor shell, the plurality of tubes optionally comprising a plurality of monoliths contained within the plurality of tubes.

Embodiment 8. The method of Embodiment 7, wherein the reactor comprises a shell, the fuel flow path comprises a portion of the reactor volume within the shell, and the oxidant flow path comprises one or more conduits providing fluid communication between an end of the recuperation zone and the mixing zone.

Embodiment 9. The method of any of the above embodiments, a) wherein the reforming flow channels are substantially free of fluid communication with the heating flow channels; b) wherein reforming the at least a portion of the at least one hydrocarbon comprises reforming without exposing a portion of the fuel, a portion of the oxidant flow, or a portion of the oxidized product flow to the reforming conditions; c) wherein the reforming input flow and the reforming product flow are not mixed with the fuel, the oxygen-containing gas, and the oxidized product flow within the reforming flow channels; or d) a combination of two or more of a), b), and c).

Embodiment 10. The method of any of the above embodiments, wherein the reacting comprises partial oxidation of the fuel, the oxidized product comprising CO, CO₂, and H₂O.

Embodiment 11. The method of Embodiment 10, further comprising reforming at least a portion of the fuel by exposing at least a portion of the fuel in the heating flow channels to a second reforming catalyst within the heating flow channels, wherein optionally a total weight of the second reforming catalyst in the heating flow channels is 25% or less of a total weight of the reforming catalyst in the reforming flow channels.

Embodiment 12. A counter-current reforming reactor, comprising: a reactor volume comprising a recuperation zone, one or more mixing elements in a mixing zone, a reforming zone, a first plurality of flow channels, and one or more second flow channels, at least a portion of the first plurality of flow channels residing in the reforming zone, the at least a portion of the first plurality of flow channels comprising reforming catalyst on one or more surfaces of the first plurality of flow channels in the reforming zone, the mixing zone being adjacent to the recuperation zone, an opposing side of the mixing zone being adjacent to the reforming zone, the one or more second flow channels being arranged around the first plurality of flow channels, wherein the recuperation zone comprises at least an oxidant flow path and a fuel flow path, at least one of the fuel flow path and the oxidant flow path providing fluid communication between an end of the recuperation zone and the mixing zone without providing fluid communication between the oxidant flow path and the fuel flow path in the recuperation zone.

Embodiment 13. The reactor of Embodiment 12, wherein the first plurality of flow channels and the one or more second flow channels comprise channels in one or more monoliths.

Embodiment 14. The reactor of Embodiment 12, wherein the first plurality of flow channels comprise tubes and the one or more second flow channels comprise the reactor volume in the reforming zone.

Embodiment 15. The reactor of Embodiment 14, wherein the second flow channels further comprise a second reforming catalyst on one or more surfaces of the second plurality of flow channels in the reforming zone, a total weight of the second reforming catalyst being 25% or less of a total weight of the reforming catalyst.

Additional Embodiment A. The method of any of the above embodiments, wherein the reacting comprises combustion of the fuel and the oxygen-containing gas.

While the present invention has been described and illustrated by reference to particular embodiments, those of ordinary skill in the art will appreciate that the invention lends itself to variations not necessarily illustrated herein. For this reason, then, reference should be made solely to the appended claims for purposes of determining the true scope of the present invention.

1. A method for performing counter-current reforming, comprising:
passing a fuel into a fuel flow path and an oxygen-containing gas into an oxidant flow path in a recuperation zone of a reactor volume;
passing a reforming input flow comprising at least one hydrocarbon into a plurality of reforming flow channels in a reforming zone of the reactor volume, a flow direction of the reforming input flow being substantially counter-current to a flow direction of at least one of the fuel and the oxygen-containing gas, the reforming channels comprising a reforming catalyst in the reforming zone;
mixing the fuel and the oxygen-containing gas in one or more heating flow channels of a mixing zone of the reactor volume to form a fuel mixture, the mixing zone being adjacent to the recuperation zone, an opposing side of the mixing zone being adjacent to the reforming zone;
reacting the mixture in the one or more heating flow channels in at least one of the mixing zone and the reforming zone to generate heat and an oxidized product flow, the one or more heating flow channels being arranged around the plurality of reforming flow channels;
reforming at least a portion of the at least one hydrocarbon in the reforming channels under reforming conditions to form a reforming product flow;
exhausting the reforming product flow from the recuperation zone; and
exhausting the oxidized product flow from the reforming zone.

2. The method of claim 1, wherein a peak temperature in the reforming flow channels is greater than a temperature in the reforming flow channels at an end of the recuperator zone by 200° C. or more.

3. The method of claim 1, wherein a peak temperature in the reforming flow channels is greater than a temperature in the reforming flow channels at an end of the reforming zone by 50° C. or more.

4. The method of claim 1, wherein the plurality of reforming flow channels comprise a plurality of channels in one or more monoliths.

5. The method of claim 4, wherein the one or more heating flow channels comprise a plurality of channels in the one or more monoliths.

6. The method of claim 4, wherein the reforming zone comprises a plurality of first monoliths and a plurality of second monoliths, the plurality of first monoliths comprising the plurality of reforming flow channels, the plurality of second monoliths comprising the plurality of heating flow channels.

7. The method of claim 1, wherein the plurality of reforming flow channels comprise a plurality of tubes, the reactor volume comprising a reactor shell.

8. The method of claim 7, wherein the plurality of tubes comprise a plurality of monoliths contained within the plurality of tubes.

9. The method of claim 1, wherein the reforming flow channels are substantially free of fluid communication with the heating flow channels.

10. The method of claim 1, wherein reforming the at least a portion of the at least one hydrocarbon comprises reforming without exposing a portion of the fuel, a portion of the oxidant flow, or a portion of the oxidized product flow to the reforming conditions.

11. The method of claim 1, wherein the reforming input flow and the reforming product flow are not mixed with the fuel, the oxygen-containing gas, and the oxidized product flow within the reforming flow channels.

12. The method of claim 1, wherein the fuel flow path and the oxidant flow path comprise channels in one or more recuperator monoliths.

13. The method of claim 1, wherein the reactor comprises a shell, the fuel flow path comprises a portion of the reactor volume within the shell, and the oxidant flow path comprises one or more conduits providing fluid communication between an end of the recuperation zone and the mixing zone.

14. The method of claim 1, wherein the reacting comprises combustion of the fuel and the oxygen-containing gas.

15. The method of claim 1, wherein the reacting comprises partial oxidation of the fuel, the oxidized product comprising CO, CO₂, and H₂O.

16. The method of claim 15, further comprising reforming at least a portion of the fuel by exposing at least a portion of the fuel in the heating flow channels to a second reforming catalyst within the heating flow channels.

17. The method of claim 16, wherein a total weight of the second reforming catalyst in the heating flow channels is 25% or less of a total weight of the reforming catalyst in the reforming flow channels.

18. A counter-current reforming reactor, comprising:
a reactor volume comprising a recuperation zone, one or more mixing elements in a mixing zone, a reforming zone, a first plurality of flow channels, and one or more second flow channels, at least a portion of the first plurality of flow channels residing in the reforming zone, the at least a portion of the first plurality of flow channels comprising reforming catalyst on one or more surfaces of the first plurality of flow channels in the reforming zone, the mixing zone being adjacent to the recuperation zone, an opposing side of the mixing zone being adjacent to the reforming zone, the one or more second flow channels being arranged around the first plurality of flow channels,
wherein the recuperation zone comprises at least an oxidant flow path and a fuel flow path, at least one of the fuel flow path and the oxidant flow path providing fluid communication between an end of the recuperation zone and the mixing zone without providing fluid communication between the oxidant flow path and the fuel flow path in the recuperation zone.

19. The reactor of claim 18, wherein the first plurality of flow channels and the one or more second flow channels comprise channels in one or more monoliths.

20. The reactor of claim 18, wherein the first plurality of flow channels comprise tubes and the one or more second flow channels comprise the reactor volume in the reforming zone.

21. The reactor of claim 18, wherein the second flow channels further comprise a second reforming catalyst on one or more surfaces of the second plurality of flow channels in the reforming zone, a total weight of the second reforming catalyst being 25% or less of a total weight of the reforming catalyst.
